(19) United States
(12) Patent Application Publication
(10) Pub. No.: US 2012/0199688 A1
(43) Pub. Date: Aug. 9, 2012

(54) METHOD AND DEVICE FOR STORING SURPLUS COMPOSITE CABLE UNDER TENSION

(76) Inventor: Andrew Conaway, Amsterdam (NL)

(21) Appl. No.: 13/024,170

(22) Filed: Feb. 9, 2011

(51) Int. Cl. B65H 75/14; B23P 11/00; B23P 6/00; B65H 75/18

(52) U.S. Cl. 242/610.5; 242/614; 242/610.6; 29/428; 29/402.01

(57) ABSTRACT

A surplus cable storage device including a top portion, a bottom portion, and an interior portion having a space with an input and an output through its geometric center is provided. The interior portion may include a grooved edge in the outer side and a shape having rounded corners. The space in the interior portion has a width that allows a plurality of diameters of the surplus cable to pass through and wind around the grooved edge. In some embodiments, the top portion and the interior portion protrude out of the grooved edge on either side of the interior portion, protecting the surplus cable wound around the grooved edge. A method for storing surplus cable attached from a lever to an actuator a manually operated apparatus and maintaining cable and apparatus is provided. The method includes winding the surplus cable along an edge of a storage device as above.

### BACKGROUND

1. Field of Invention

Embodiments disclosed herein generally relate to the field of bicycle accessories manufacturing, and in particular, storing surplus cable under tension for use in a bicycle or other manually operated apparatus.

2. Description of Prior Art

Bicycle cables are composite cables made of many strands of thinner cables twisted around each other. Bicycle cables are used mostly to provide tensile energy for moving parts within the bicycle. For example, some applications use cables to provide tension to the brakes in the system. One end of the cable is attached to a lever that may be manually pressed by the rider. The other end of the cable may be attached to a braking element such as a caliper having two arms, each arm holding a braking pad. When the rider presses the lever, tensile energy is transmitted through the cable to move the two arms in the caliper against the wheel. The braking pads press on the wheel rim, producing the desired slowing effect.

Some applications use bicycle cables for a gear-shift mechanism in the bicycle. In this case, a derailleur coupled to the bicycle chain is used to shift the plane of rotation of the chain according to a gear cogset. A gear cogset is a set of multiple rear sprockets usually attached to the hub of the rear wheel. As the derailleur moves in and out in a direction along the axis of the cogset, it aligns itself with the plane of each sprocket sequentially. Thus, the derailleur aligns the bicycle chain with a specific sprocket in the rear wheel, providing traction power from the pedal crankshaft. The pedal crankshaft may include several chain rings, which are sprockets coupling the chain to the crankshaft. Usually one, two, or three sprockets having different sizes may be included for the pedal crankshaft in a bicycle. A front derailleur may also be used to select between each of the chainrings in the pedal crankshaft. The front derailleur is also operated by the rider using a lever. A cable coupling the lever to the front derailleur provides the tensile energy to move the derailleur to the desired position.

More generally, actuating mechanisms in a manually operated apparatus include a lever coupled to an actuator by a cable under tension. The actuator may be a caliper for a braking mechanism, a drum brake, or a derailleur for gear-shift. The precise length of the cable coupling the lever and the actuator determines the tensile energy transmitted to the actuator by the operator of the apparatus. If the cable has ‘slack,’ the displacement of the lever will need to be larger in order to provide enough tension to the actuator. On the other hand, a shorter cable may result in an overly sensitive actuator. This may be the case for an over-tight brake system, or a derailleur having an insufficient range. The precise length of a bicycle cable is typically adjusted using a fastener and a screw or bolt. The fastener attaches the end of the cable to the actuator, thus defining the length of the cable between the lever handled by the rider and the actuator.

When a fastener is applied to secure the end of the cable to the actuator the cable may be crushed. This may be due to the high amount of stress applied by a bolt in the fastener to secure the cable to the actuator. A considerable amount of stress may be used to avoid cable slippage from the fastener bolt. Cable slippage may disrupt the operation of bicycle brakes, gear shifts, or other mechanisms. Cable slippage may cause malfunction and or loss of control of the bicycle. While avoiding actuator malfunction, a high tightening stress ultimately bends, kinks, or crushes some of the strands of the cable, causing the cable to fray.

When a cable becomes kinked or frayed it becomes difficult to perform any maintenance on the cable. Cable maintenance may involve using a lubricant to keep the cable moving easily through the cable housing. Also, maintenance procedures may include cleaning the cable from rust growth due to weather conditions. Cable maintenance may be applied repeatedly, at regular intervals. Cable fraying may cause needle-like wires to protrude out and render the cable difficult to work with during maintenance procedures. During maintenance, the cable is detached from the actuator, and cleaned or tended to. Then the cable is re-routed through the cable housing and re-attached to the actuator, using a bolt or a screw in a fastener. Kinked or frayed cable cannot be taken out and re-routed through the cable housing to be re-attached to the actuator because the cable has lost its shape. It becomes difficult and time-consuming, if not impossible, to rethread the cable into the fastener hole through the housing. Thus, according to current state-of-the-art, disconnecting a bicycle cable from the actuator for maintenance typically requires a new cable.

What is needed is a method and a device providing a way to disconnect a controlling cable from an actuator while allowing reconnecting the same cable back to the actuator, adding surplus cable length. What is also needed is a method and a device to perform maintenance on a bicycle cable without having to replace the entire length of the cable, using stored surplus cable.

### SUMMARY

According to embodiments disclosed herein a surplus cable storage device may include a top portion, a bottom portion, and an interior portion having a space with an input and an output through its geometric center. The interior portion may include a grooved edge in the outer side and a shape having rounded corners. In some embodiments the space in the interior portion has a width that allows a plurality of diameters of the surplus cable to pass through and wind around the grooved edge of the interior portion. In some embodiments, the top portion and the interior portion protrude out of the grooved edge on either side of the interior portion, to protect the surplus cable wound around the grooved edge.

A method for storing surplus cable attached from a lever to an actuator in a manually operated apparatus, according to embodiments disclosed herein, may include threading a length of cable from the lever to the actuator through a cable housing in the apparatus until an amount of surplus cable is obtained between an anchor point in the cable housing and a fastener in the actuator. The method may further include threading the surplus cable from an input to an output of a storage device and forming a loop by winding the surplus cable along an edge of the storage device. In some embodiments, the method includes attaching the unwound cable to a fastener in the actuator side.

A method for providing maintenance to a manually operated apparatus having a cable attached from a lever to an actuator in the apparatus may include detaching cable from a fastener in the actuator, removing cable from a cable housing, and performing a maintenance procedure. The method may further include threading a length of cable from the lever to the actuator through a cable housing in the apparatus until an amount of surplus cable is obtained between an anchor point in the cable housing and a fastener in the actuator. In some embodiments, the method includes threading the surplus cable from an input to an output of a storage device forming a loop by winding the surplus cable along an edge of the storage device and attaching the unwound cable to a fastener in the actuator side.

These and other embodiments are further discussed below with reference to the following figures.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designation have the same or similar functions.

FIG. 1 illustrates a partial view of a device for storing surplus cable according to some embodiments.

FIG. 2 illustrates a partial view of a device for storing surplus cable according to some embodiments.

FIG. 3 illustrates surplus cable in the interior portion of a device for storing surplus cable, according to some embodiments.

FIG. 4 illustrates several devices for storing surplus cable in a bicycle, according to some embodiments.

FIG. 5 is a flow chart for a method to store surplus cable according to some embodiments.

FIG. 6 is a flow chart for a method to provide maintenance to an apparatus including a cable under tension, according to some embodiments.

### DETAILED DESCRIPTION

It is to be understood that the following disclosure provides many different embodiments, or examples, for implementing different features of the invention. Specific examples of components and arrangements are described below to simplify the present disclosure. These are, of course, merely examples and are not intended to be limiting. Various features may be arbitrarily drawn in different scales for simplicity and clarity.

A bicycle cable generally lasts between 12-24 months before it has to be replaced, or before a maintenance procedure needs to be performed on the cable. According to some embodiments disclosed herein, a cable storage device may store surplus cable within the cable path itself. Thus, surplus cable length may be available as needed, while maintaining the cable under high tension. Only a sufficient length of cable may be unwound from the cable storage device for use at a given time. Thus keeping a stock of surplus cable wound in the cable storage device, for future use. Surplus cable stored in the cable storage device according to embodiments disclosed herein is neither frayed nor kinked. The cable may easily traverse the cable housing, bolt holes, anchor points and other small routing holes in the derailleur, the brake mechanism, or any other actuator in the bicycle. Surplus cable can be refastened easily upon release from the cable storage device.

Having a stock of surplus cable eliminates the need to replace the entire length of cable every time the cable needs to be detached from the actuator for maintenance. Whether maintenance is needed for the cable itself or for a component in the bicycle that is within the cable path, some maintenance procedures may include detaching the cable from the actuator. According to methods disclosed herein for performing maintenance procedures, when a cable is detached from an actuator the frayed portion of the cable may be simply clipped from the end of the cable. Once maintenance is provided to the cable or to any other component in the bicycle, surplus cable length stored in the cable storage device may be unwound to replace the cut portion. Thus re-establishing the cable length between lever and actuator.

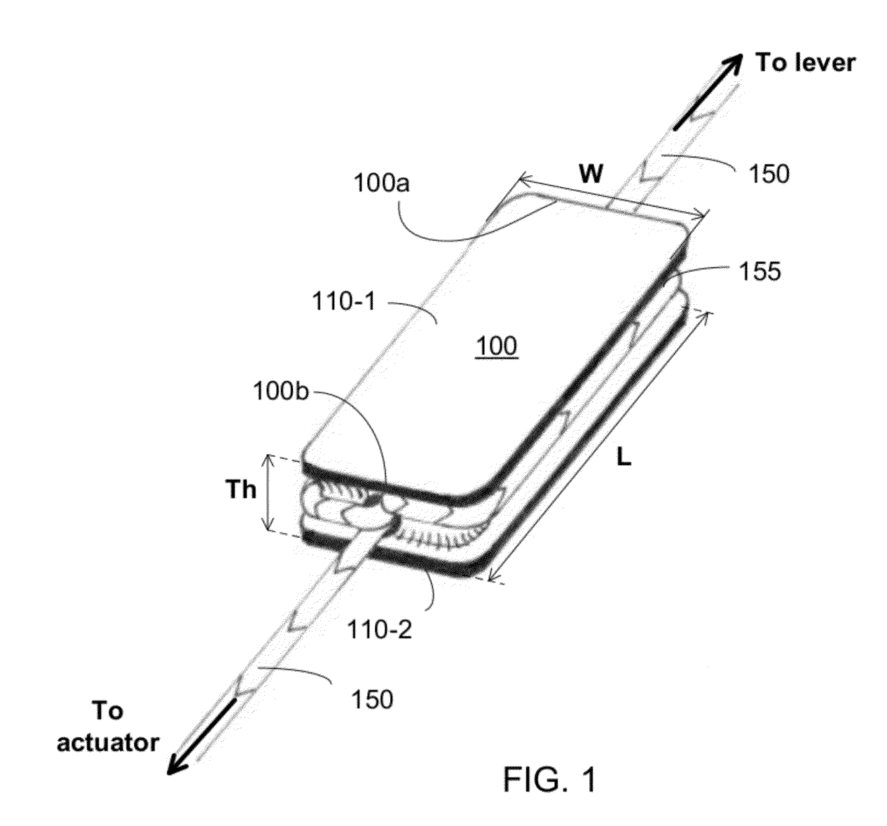

FIG. 1 illustrates a partial view of cable storage device 100 for storing surplus cable 155 according to some embodiments. Device 100 may be formed in a rectangular shape of a specified length, L, width, W, and thickness, Th. According to embodiments consistent with FIG. 1, device 100 includes top portion 110-1 and bottom portion 110-2. The denomination ‘top’ or ‘bottom’ is arbitrary, and is only used for guidance with respect to the illustration in FIG. 1. In general, once the device is put in place, portions 110-1 and 110-2 may be on the top, bottom, or in any orientation relative to other components of a bicycle.

According to the illustration in FIG. 1, cable 150 may be under tension. One end of cable 150 is closer to a lever in the bicycle, and the other end of cable 150 is closer to an actuator, as depicted in FIG. 1. A surplus portion 155 of cable 150 is tightly wound around device 100. Thus, a direct coupling between a lever and an actuator is maintained by device 100 while surplus cable 155 is available for use when necessary. In some embodiments, the portion of cable 150 closer to a lever in the bicycle may be directly attached to the lever. Also, in some embodiments the portion of cable 150 closer to a bicycle actuator may be directly attached to a fastener in the actuator. Some embodiments may include intervening portions of cable housing between storage device 100 and a bicycle lever, or between storage device 100 and a bicycle actuator. The side of device 100 closer to the bicycle lever is ‘input’ side 100a in FIG. 1. The side of device 100 closer to the bicycle actuator is ‘output’ side 100b in FIG. 1. There is nothing limiting regarding the labeling of ‘input’ and ‘output’ to sides 100a and 100b. In fact, embodiments consistent with FIG. 1 may be turned around so that side 100a becomes ‘output’ side and 100b becomes ‘input’ side, without loss of functionality of device 100.

Cable 150 may be any type of composite cable used in bicycles or other manually operated apparatuses. In some embodiments cable 150 is a Bowden cable. A Bowden cable is a flexible cable having an inner cable that moves relative to a hollow outer housing to provide tensile energy. The housing may be a composite construction including helical steel wire lined with plastic, having an outer sheath made of plastic.

Storage device 100 may be formed from an incompressible, lightweight solid material such as wood, hard plastic, or metal. In some embodiments, device 100 may be formed of a composite material including wood, hard plastic, and or metal. Storage device 100 may be in the path of cable 150 providing tensile energy from a lever to an actuator. Thus, incompressibility of device 100 enables an efficient transfer of tensile energy from input side 100a to output side 100b, when the lever is pressed.

As illustrated in FIG. 1, top portion 110-1 and bottom portion 110-2 of storage device 100 may have rounded edges. Thus, a bicycle or any apparatus using storage device 100 may be safely handled by the user. Rounded edges in portions 110-1 and 110-2 avoid cuts and scratches to the user and to any other materials or components casually contacting storage device 100. In embodiments consistent with FIG. 1, top portion 110-1 and bottom portion 110-2 protrude out of the interior portion of device 100. Thus, portions 110-1 and 110-2 provide protection to surplus cable 155 stored in device 100.

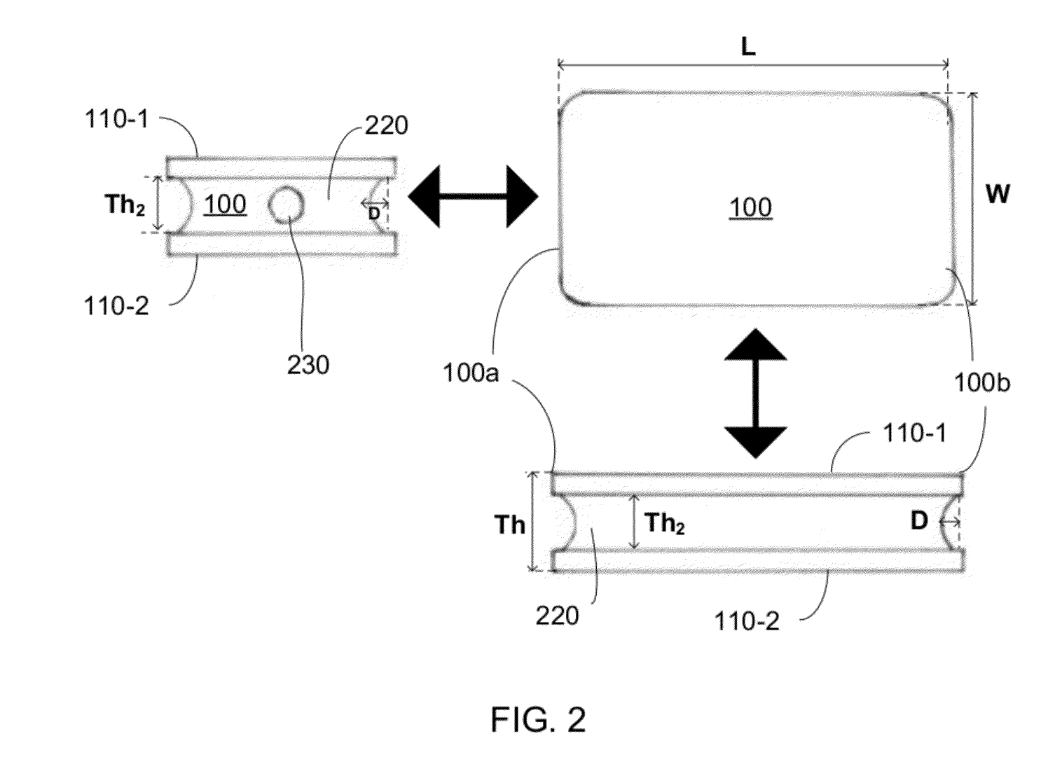

FIG. 2 illustrates a partial view of device 100 for storing surplus cable 155 according to some embodiments. FIG. 2 shows a top view of device 100 having a rectangular shape with length, L, and width, W (top right portion of FIG. 2). In general, L may be different from W, each having a dimension of a few inches. For example, in some embodiments L may be two (2) inches while W is one (1) inch. Other dimensions and shapes may be used, consistent with the concept illustrated in FIG. 2. In some embodiments, it may be desirable to have W as small as feasible, so that storage device 100 is not bulky. Thus, it may be desirable that the edges of device 100 do not stick out by a substantial amount, to prevent casual contact with the user or any other materials or components. In order to achieve this while still having a perimeter that is long enough to store a sufficient length of surplus cable 155, some embodiments of device 100 may have a relatively small W and a relatively large L. For example, W may be less than one (1) inch, or about half (0.5) an inch or less; while L may be two (2), three (3), four (4) inches, or longer. Another factor of consideration in determining the dimensions L and W of device 100 is the bending radius of cable 150. That is, in some embodiments of device 100 consistent with FIGS. 1 and 2, as cable 150 is wound around device 100, it is curled or bent by less than its bending radius, R. The bending radius, R, is the radius of curvature below which bending cable 150 introduces a permanent kink on the cable.

FIG. 2 also illustrates a front view of storage device 100 (top-left portion of FIG. 2). Top portion 110-1 and bottom portion 110-2 protect interior portion 220 of cable storage 100, where surplus cable 155 is wound. Interior portion 220 has a grooved surface around its outer edge to accommodate the cross section shape of cable 150. A grooved surface allows surplus portion 155 to converge to the center of portion 220 as cable 150 is wound around interior portion 220. The groove has a depth, D, and a thickness, Th₂, to accommodate surplus cable 155 wrapping around portion 220. Thus, surplus cable 155 will not slide off device 100, and will be protected by portions 110-1 and 110-2. The number of loops of surplus cable 155 around interior portion 220 depends on the amount of surplus cable 155 available, and the dimensions (L and W) of device 100.

According to FIG. 2 (top-left portion), space 230 may be included in the center of device 100. In some embodiments, space 230 may run through interior portion 220 from input 100a to output 100a (cf. FIG. 1). The diameter of space 230 is an integer multiple, ‘N,’ of the width of cable 150, to accommodate for N−1 loops of surplus cable 155 stored in device 100. The specific value of N may be two (2), three (3), or any number necessary to provide a sufficient amount of surplus cable 155. A side view of device 100 is shown in the bottom-right portion of FIG. 2, showing features described above.

According to embodiments consistent with FIG. 2, space 230 couples input side 100a and output side 100b through surplus cable 155. Surplus cable 155 may be under high tension, in order to transfer tensile energy from a lever coupled to input side 100a to an actuator coupled to output side 100b. An efficient tensile energy transfer from side 100a to side 100b through surplus cable 155 may be desirable. Thus, space 230 may run through the geometric center of storage device 100. This configuration provides zero torque of cable 150 on device 100. Otherwise, a compensating torque may be provided from surplus cable 155 inside device 100. A compensating torque may reduce the efficiency of tensile energy transfer through device 100.

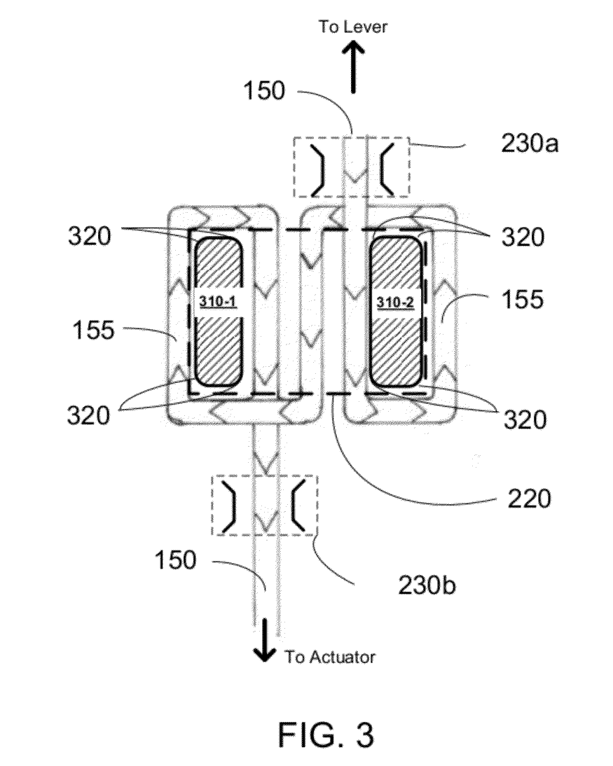

FIG. 3 illustrates surplus cable 155 in portion 220, according to some embodiments. Also shown in FIG. 3 are solid portions 310-1 and 310-2. For example, in embodiments consistent with FIGS. 2 and 3 solid portions 310-1 and 310-2 result from running space 230 through the middle of interior portion 220. Space 230 has an ‘input’ portion 230a on the side closer to the lever, and an ‘output’ portion 230b on the side closer to the actuator. As is evident from FIG. 3, the designation of ‘input’ and ‘output’ portions 230a and 230b is not specific. In fact, device 100 may be turned around and portion 230b may be the ‘input’ and portion 230a may be the ‘output,’ without loss of functionality.

Surplus cable 155 is wound around portions 310-1 and 310-2, in interior portion 220. According to embodiments consistent with FIG. 3, portions 310-1 and 310-2 may have an approximately rectangular shape with rounded edges 320. Some embodiments may have portions 310-1 and 310-2 with any other shapes, having rounded edges 320 such as shown in FIG. 3. Rounded edges 320 allow surplus cable 155 to be tightly wound around solid portions 310, without inducing a kink on surplus cable 155. The radius of curvature of edges 320 in portions 310-1 and 310-2 may vary according to the type of composite cable 150 used in the bicycle. The general principle is to provide a radius of curvature greater than bending radius R. Thus, cable 150 can sustain bending around edges 320, without having a permanent deformation or kink.

Some embodiments of device 100 may include interior portion 220 having more than two (2) solid portions 310-1, 310-2. In general, embodiments of device 100 consistent with the concept of FIG. 3 may have any number of interior portions 310, such as one (1), two (2), three (3), four (4) or more.

As illustrated in FIG. 3, surplus cable 155 is wound in interior portion 220 making two loops. A loop of surplus cable 155 winds around each one of solid portion 310-1 and 310-2. Thus, space 230 inside portion 220 has a width to allow at least three portions of cable 150 to pass through it, as shown in FIG. 3. FIG. 3 shows input portion 230a and output portion 230b at either end of space 230. According to the discussion regarding space 230 in FIG. 2, some embodiments may have input 230a and output 230b aligned with the geometric center of device 100. This configuration minimizes the amount of external torque provided by cable 150 to device 100 from input 230a and output 230b.

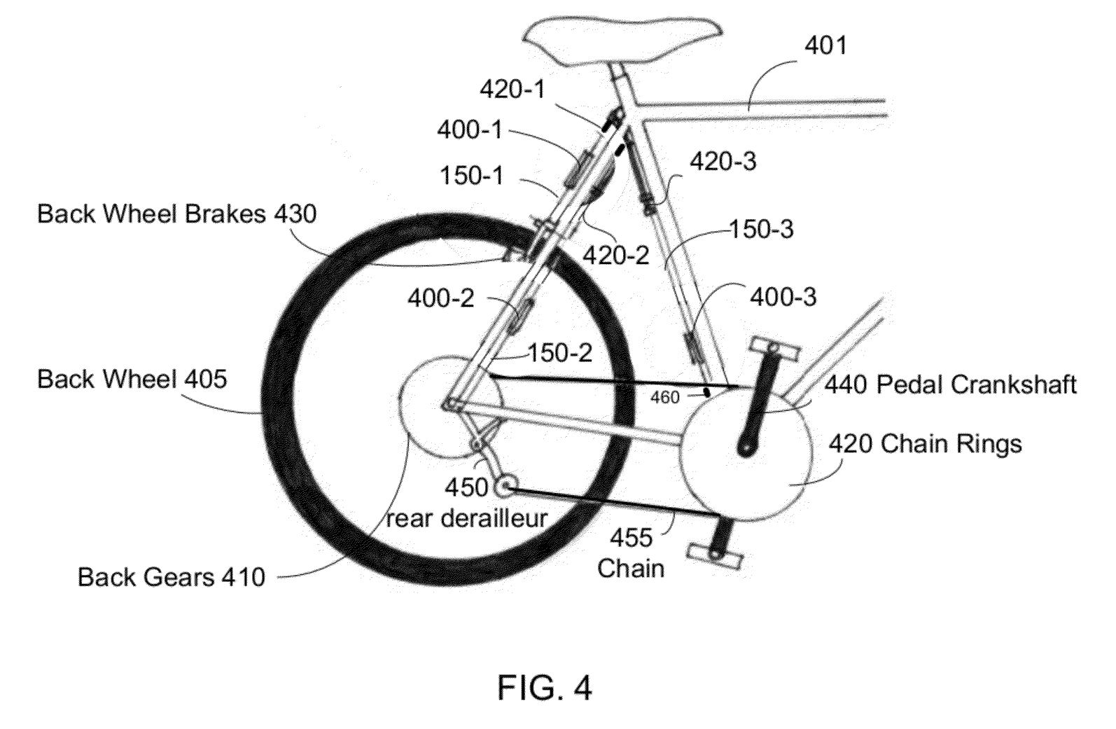

FIG. 4 illustrates several cable storage devices 400-1 to 400-3, for storing surplus cable 155 in bicycle 401, according to some embodiments. Bicycle 401 includes back wheel 405, back gears 410, chain rings 420, back wheel brakes 430, pedal crankshaft 440, rear derailleur 450, chain 455, and front derailleur 460. Not shown in FIG. 4 are the levers to provide tensile power to the different actuating mechanisms shown: brakes 430, rear derailleur 450 and front derailleur 460. Typically, the levers may be placed in the handlebar for easy access by the rider (handlebar not shown). The levers are coupled to each actuator through cables 150. As illustrated in FIG. 4, cable 150-1 couples tensile energy to back wheel brakes 430. Cable 150-2 couples tensile energy to rear derailleur 450. And cable 150-3 couples tensile energy to front derailleur 460. Each of cables 150-1 to 150-3 may have attached a surplus storage device 400. Device 400-1 provides surplus cable to cable 150-1. Device 400-2 provides surplus cable to cable 150-2. And device 400-3 provides surplus cable to cable 150-3.

Also shown in FIG. 4 are anchor points 420-1 to 420-3 included as part of the cable housing for bicycle 401. Anchor points 420-1 to 420-3 provide support to cables 150-1 to 150-3 to keep proper routing from a lever to the input portion of devices 400-1 to 400-3. During maintenance procedures including removal of either of cables 150-1 to 150-3, the cable is re-routed out of their housing through anchor points 420-1 to 420-3. In some embodiments, a maintenance procedure may involve only detaching either of cables 150-1 to 150-3 from the actuator, without the need to re-route the cable through its respective anchor point 420.

In some embodiments, a maintenance procedure needs to be performed to the entire length of cable 150-i, such as cleaning the cable from rust, or coating the cable with a lubricant. Cable 150-i may also be removed entirely to provide maintenance to the cable housing. For example, anchor points 420 may need to be cleaned from rust or dirt. And the cable housing may need to be coated in lubricant or have rust removed from it. In these cases the entire cable 150-i may be removed from bicycle 401. Thus, cable 150-i is detached from the actuator and unwound from storage device 400-i. Further, cable 150-i is taken out of its housing by passing it through anchor point 420-i to reach the lever.

In some embodiments, a maintenance procedure needs to be performed on an actuator such as brakes 430 or derailleurs 450 or 460. For example, one of the actuators may in fact need to be replaced by a new actuator. In such cases, cable 150-i may be detached only from a specific actuator without being taken out from anchor point 420-i. Cable 150-i may then be re-attached to an actuator once the maintenance procedure is completed.

Once the maintenance procedure is completed, it may be necessary to clip the tip of cable 150-i before re-attaching to an actuator. This may be the case when cable 150-i has been frayed or kinked by stress from a bolt or screw in the actuator fastener. Thus, a loop or more of surplus cable 155 may be retrieved from storage device 400-i to account for the loss of cable length after clipping.

According to embodiments consistent with FIG. 4, storage device 400-i is located in the cable path between anchor point 420-i and its respective actuator. This configuration is convenient because surplus cable 155 will most likely be needed at the point of attachment to the actuator. For example to replace cable length that has been clipped at the fastener point due to stress by the bolt in the fastener. Some embodiments consistent with the concept illustrated in FIG. 4 may include cable storage 400-i located between a lever and anchor point 420-i.

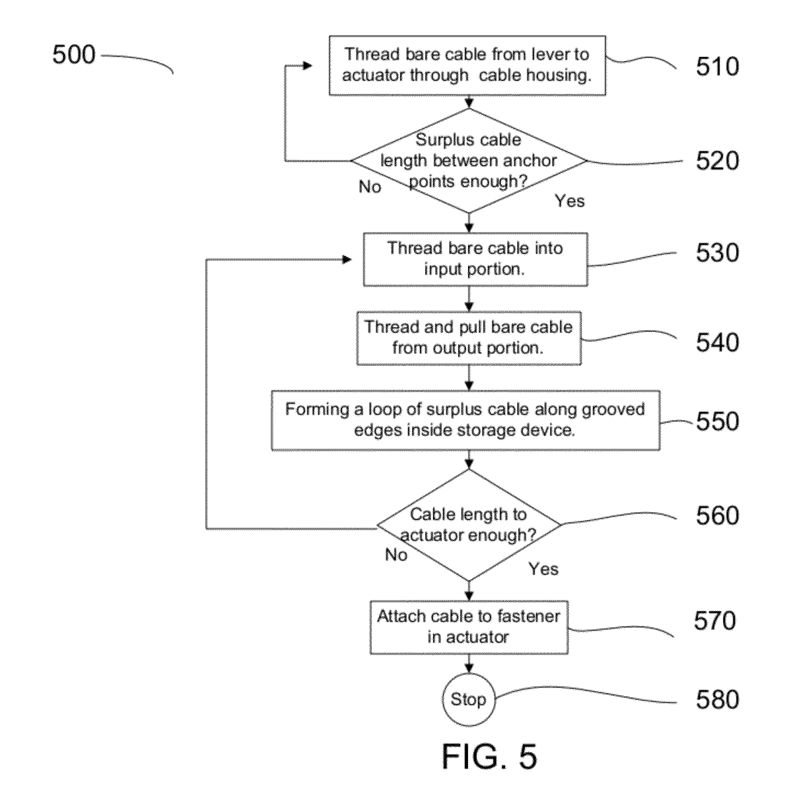

FIG. 5 is a flow chart for method 500 to store surplus cable 155 under tension, according to some embodiments. According to embodiments consistent with FIG. 5, method 500 may include threading bare cable through the cable housing from a lever to the actuator in step 510. The threading continues until sufficient surplus cable 155 between anchor points in the cable housing has been allocated, as determined in step 520. For example, in embodiments consistent with FIG. 4, step 520 queries for a sufficient length of surplus cable 155 between anchor point 420-i and the actuator. In step 530, cable 150 is threaded into portion 230a of device 100. In step 540, cable 150 is threaded out of device 100 through portion 230b. Curling and threading surplus cable 155 along the grooved edges around and inside device 100 occurs in step 550. Steps 530 through 550 are repeated N times, until cable 150 reaches a desired length, as determined in step 560. The procedure is terminated in step 570. A total of N−1 surplus cable loops may be wound around the interior portion 220 of device 100. Thus, the performance of cable 150 in transmitting tensile energy from lever to actuator is not affected by the placement of storage device 100. Storage device 100 increases the lifetime of cable 150 by providing surplus cable 155 as needed.

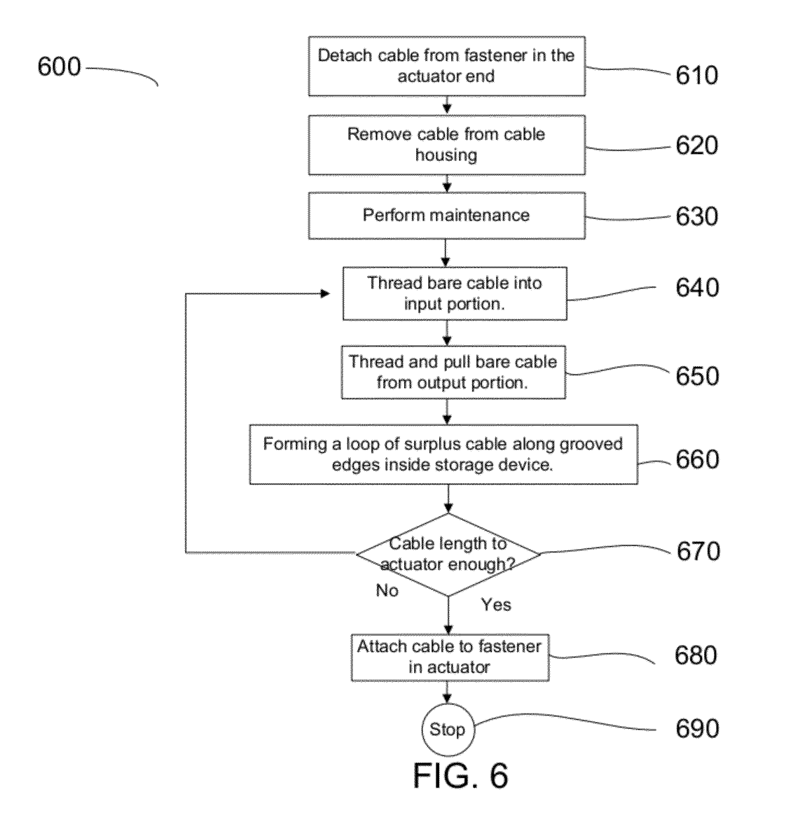

FIG. 6 is a flow chart for method 600 to provide maintenance for cable 150 according to some embodiments. Cable 150 is detached from a fastener in the actuator end, in step 610. Removing cable from housing takes place in step 620. Step 620 may include unwinding surplus cable 155 out of device 100 and re-routing cable 150 out the cable housing. In some embodiments, step 620 further includes pulling the clean cable out through the cable housing and releasing a section of stored cable.

In step 630 a maintenance procedure is performed. According to embodiments of method 600 maintenance procedures may be directed to cable 150. In some embodiments, maintenance procedures in step 630 may be directed to other components of the bicycle or apparatus using the cable. For example, either one or both of the lever and the actuator mechanisms may need repair or replacement. In such cases, temporary removal of the cable may be necessary in order to have direct access to the components being repaired or replaced. In some embodiments, step 630 may include clipping the cable at a point before the frayed portion, near the fastener. In step 640, cable 150 is threaded into portion 230a of device 100. Threading and pulling cable 150 through portion 230b out of device 100 in step 650. Curling and threading surplus cable 155 along the grooved edges around and inside device 100 takes place in step 660. Steps 640 through 660 are repeated M times, until cable 150 reaches a desired length, as determined in step 670. The procedure is terminated in step 680. A total of M−1 surplus cable loops may be wound around the interior portion 220 of device 100. The number of surplus cable windings at the end of procedure 600, M, may be equal or less than the number of surplus cable windings, N, before procedure 600 is carried out.

Cable storage device 100 may thus extend the life of bicycle cables three or more times longer than available in state-of-the-art applications. This is achieved by providing surplus clean cable instead of having to purchase completely new cable each time the cable needs to be disconnected from the brake or derailleur.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Embodiments of the methods and apparatus disclosed herein and consistent with FIGS. 1 through 6 above may find applications where the use of cables for coupling tensile energy from a lever to an actuator is desirable. These applications may involve the design and manufacturing of accessories for a bicycle or other sporting apparatus and structure. For example, tricycles and other man-powered transportation apparatus may include device 100. Also, manually operated apparatuses such as gliders, boats, and sailing boats may use embodiments of the methods and devices as disclosed heretofore.

Those skilled in the art should also realize that such equivalent constructions do not depart from the spirit and scope of the present disclosure, and that they may make various changes, substitutions and alterations herein, without departing from the spirit and scope of the present disclosure. The present disclosure is limited only by the following claims.

What is claimed is:

1. A surplus cable storage device, comprising:
a top portion;
a bottom portion;
an interior portion having a space with an input and an output through its geometric center, a grooved edge in an outer side, and a shape having rounded corners, the space in the interior portion having a width that allows a plurality of diameters of the surplus cable to pass through and wind around the grooved edge of the interior portion; wherein
the top portion and the interior portion protrude out of the grooved edge on either side of the interior portion to protect the surplus cable wound around the grooved edge.

2. The device of claim 1 wherein at least the interior portion is made of an incompressible material.

3. The device of claim 2 wherein the incompressible material is a plastic, a metal, or hard wood.

4. The device of claim 1 wherein the top portion, the bottom portion, and the interior portion are formed into a single piece.

5. The device of claim 1 wherein the top portion and the bottom portion protrude out of every side along the perimeter of the interior portion, forming a rectangular shape having a width, a length, and a thickness.

6. The device of claim 5 wherein the length is larger than the width, and the thickness is larger than a plurality of times the diameter of the surplus cable.

7. A method for storing surplus cable attached from a lever to an actuator in a manually operated apparatus, comprising
threading a length of cable from the lever to the actuator through a cable housing in the apparatus until an amount of surplus cable is obtained between an anchor point in the cable housing and a fastener in the actuator;
threading the surplus cable from an input to an output of a storage device;
forming a loop by winding the surplus cable along an edge of the storage device;
attaching the unwound cable to a fastener in the actuator side.

8. The method of claim 7 wherein the storage device comprises:
a top portion;
a bottom portion;
an interior portion having a space with an input and an output through its geometric center, a grooved edge in an outer side, and a shape having rounded corners, the space in the interior portion having a width that allows a plurality of diameters of the surplus cable to pass through and wind around the grooved edge of the interior portion; wherein
the top portion and the interior portion protrude out of the grooved edge on either side of the interior portion, to protect the surplus cable wound around the grooved edge.

9. The method of claim 7 wherein the threading the surplus cable from an input to an output of the storage device and the forming a loop is repeated a plurality of times until the length of the cable from the lever to the actuator is appropriate to keep cable tension.

10. The method of claim 7 wherein the manually operated apparatus is a bicycle.

11. The method of claim 7 wherein the manually operated apparatus is a boat.

12. The method of claim 7 wherein the manually operated apparatus is a flying device.

13. A method for providing maintenance to a manually operated apparatus having a cable attached from a lever to an actuator in the apparatus, the method comprising
detaching cable from a fastener in the actuator;
removing cable from a cable housing;
performing a maintenance procedure;
threading a length of cable from the lever to the actuator through a cable housing in the apparatus until an amount of surplus cable is obtained between an anchor point in the cable housing and a fastener in the actuator;
threading the surplus cable from an input to an output of a storage device;
forming a loop by winding the surplus cable along an edge of the storage device;
attaching the unwound cable to a fastener in the actuator side.

14. The method of claim 13 wherein the storage device comprises:
a top portion;
a bottom portion;
an interior portion having a space with an input and an output through its geometric center, a grooved edge in an outer side, and a shape having rounded corners, the space in the interior portion having a width that allows a plurality of diameters of the surplus cable to pass through and wind around the grooved edge of the interior portion; wherein
the top portion and the interior portion protrude out of the grooved edge on either side of the interior portion, to protect the surplus cable wound around the grooved edge.

15. The method of claim 14 wherein the maintenance procedure comprises clipping one end of the surplus cable.

16. The method of claim 15 wherein the maintenance procedure is performed on a component of the manually operated apparatus.

17. The method of claim 14 wherein the maintenance procedure is performed on the cable attached from the lever to the actuator.

18. The method of claim 17 wherein the maintenance procedure comprises lubricating the cable.
